(19) United States
(12) Patent Application Publication
(10) Pub. No.: US 2012/0299258 A1
(43) Pub. Date: Nov. 29, 2012

(54) PORTABLE TREE STAND AND SYSTEM FOR HUNTING

(75) Inventors: Daniel P. Gallagher, Tinley Park, IL (US); Robert E. McCarthy, Crete, IL (US)

(73) Assignee: Outdoor Life Products, LLC, Frankfort, IL (US)

(21) Appl. No.: 13/359,260

(22) Filed: Jan. 26, 2012

Related U.S. Application Data
(60) Provisional application No. 61/436,493, filed on Jan. 26, 2011.

(51) Int. Cl. A01M 31/02; B23P 11/00; B62B 1/00

(52) U.S. Cl. 280/47.18; 182/115; 182/102; 29/426.2; 29/401.1

(57) ABSTRACT

A portable tree stand includes a base and a telescoping ladder. The base includes a platform and an attachment bracket mounted to the platform. The ladder is telescopically movable over a range over travel between a collapsed position and an extended position. The ladder includes a top rung segment having a top rung. The top rung of the telescoping ladder is removably attached to the attachment bracket of the base, A user can secure the tree stand base in an elevated position to a tree, disconnect the ladder from the base in the elevated position, and use the ladder to access another tree stand base in an elevated position at another site or other basic functions. Additionally, the ladder can be modified to be used as a game carrier cart.

### CROSS-REFERENCE TO RELATED APPLICATION

This patent application claims the benefit of priority to U.S. Provisional Patent Application No. 61/436,493, filed Jan. 26, 2011, and entitled “Portable Tree Stand and System for Hunting,” which is incorporated in its entirety herein by this reference.

### TECHNICAL FIELD

This patent disclosure relates generally to tree stands and, more particularly, to portable tree stands and associated systems for hunting.

### BACKGROUND

Hunters, photographers and observers of wildlife conventionally use tree stands to decrease the possibility of being noticed by the animals or to obtain a higher vantage point than the ground from which to view animals. A tree stand allows a person to maintain a proximate position relative to the animals while at the same time decreasing the possibility of frightening or scaring off the animals. Additionally, by elevating a person above the ground, the tree stand can enable a person to see over low vegetation or other obstacles giving the person a better line of sight to an animal. In particular, bow hunters prefer tree stands because they generally prefer to be much closer to the animal than a hunter with a firearm and the features previously mentioned tend to allow the hunter a much closer shot.

Conventional tree stands typically include a platform suitable for at least one person to sit or stand so that the person is several feet above the ground (commonly six feet or more). Because these elevated platforms are used to hunt or view wild animals, tree stands are typically placed in relatively remote areas, many of which are also relatively inaccessible.

Tree stands generally come in four varieties: tower stands, climbing stands, ladder stands, and hang on stands. Although not mounted to a tree, a tower stand can be used in areas where there are no trees or the trees in that area are not suitable to mount a tree stand. The tower stand typically includes a plurality of legs which meet at the top to support a seat. This gives the hunter an elevated viewpoint without having to climb a tree. However, the weight and size of the stand diminish its portability.

Climbing stands typically include a pair of platform is that allow the hunter to maneuver up a tree to a desired height. Climbing stands generally have a lower climbing platform upon which the hunter stands and an upper climbing platform upon which the hunter sits. Each of the upper and lower climbing platforms has a toothed edge or jaw member for biting the front side of the tree and a cable or blade device attached to the climbing platform which encircles the backside of the tree, thereby supporting the climbing platform in a cantilevered position. The jaws or blades bite into the tree, by pivotal action of the climbing platform, to hold each climbing platform in place after the tree stand is located in the desired position on the tree. Each climbing platform may be released or repositioned by simultaneously raising or lifting the climbing platform while releasing the cable or blade device encircled about the tree to disengage the climbing platform. The lower climbing platform includes foot straps or foot receiving members that are typically required to be engaged by a hunter for manipulating the position of the lower climbing platform. The hunter typically manipulates and positions the upper climbing platform with his hands.

The upper platform is moved up while standing on the lower platform. The hunter then puts weight on the upper platform, brings the lower platform upward, and steps back down on the lower platform. This procedure continues until the hunter reaches the desired height. The necessary physical requirements for climbing can cause a climbing stand to be difficult to use for some people.

Hang on stands typically include a seat and a footrest that is attached to the tree. This type of tree stand is relatively lightweight and allows reasonable portability. However, the hunter is required to the climb the tree by installing climbing steps, using a climbing stick, or climbing up limbs.

A ladder stand typically includes a ladder with a seat at the top. The entire assembly is then secured to the tree such that the hunter can climb the ladder to get into and out of the tree stand. While it is much easier to climb the ladder than the tree, conventional ladder stands are bulky and not readily portable.

It will be appreciated that this background description has been created by the inventor to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

Embodiments of a portable tree stand and a hunting system are disclosed. The portable tree stand can include a telescoping ladder and a base removably connected together via a universal attachment bracket. In some embodiments, a plurality of bases can be provided each having a universal attachment bracket mounted thereto. A telescoping ladder can be selectively coupled with one of the bases. The bases can each be mounted in an elevated position to a selected tree throughout a designated outdoor area to provide multiple elevated observation locations which can be selectively accessed via the telescoping ladder, which can be readily transported by the outdoorsman.

In one embodiment, a portable tree stand includes a base and a ladder. The base includes a platform and an attachment bracket mounted to the platform. The ladder is movable over a range over travel between a collapsed position and an extended position. The ladder includes a set of rungs. The ladder is removably attached to the attachment bracket of the base.

In other embodiments, a backpack assembly can be provided to facilitate the transportation of the telescoping ladder. In another aspect, a telescoping ladder can be converted into a ladder cart by attaching a wheel assembly and a pivotable game carrier to one end of the ladder and a handle bar to the other end of the ladder.

In yet another embodiment, a method of using a portable tree stand is disclosed. A ladder is attached to a base that includes a platform. The ladder is moved from a collapsed position to an extended position with the ladder supporting the base. The base is secured in an elevated position to an object. The ladder is disconnected from the base, thereby leaving the base secured to the object in the elevated position.

Further and alternative aspects and features of the disclosed principles will be appreciated from the following detailed descriptions and the accompanying drawings. As will be appreciated, the principles related to tree stands and hunting systems disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a perspective view of an embodiment of a tree stand constructed in accordance with principles of the present disclosure.

FIG. 2 is a front elevational view of an embodiment of a base and a fragmentary front elevational view of a telescoping ladder of a tree stand constructed in accordance with principles of the present disclosure.

FIG. 3 is a side elevational view of the base of FIG. 2 and a fragmentary side elevational view of the telescoping ladder of FIG. 2.

FIG. 4 is a view as in FIG. 3, illustrating a top rung of the telescoping ladder removably attached to a universal attachment bracket of the base of FIG. 2.

FIG. 5 is a front elevational view of the telescoping ladder of FIG. 1, illustrating the telescoping ladder in a fully-collapsed position.

FIG. 6 is a front elevational view of an embodiment of a backpack constructed in accordance with principles of the present disclosure and suitable for use to transport a telescoping ladder suitable for use in a tree stand constructed in accordance with principles of the present disclosure.

FIG. 7 is a side elevational view of the backpack of FIG. 6.

FIG. 8 is a perspective view of an embodiment of a ladder cart constructed in accordance with principles of the present disclosure.

FIG. 9 is a fragmentary, rear elevational view of a connection mechanism of a wheel assembly of the ladder part of FIG. 8.

FIG. 10 is a side elevational view of the connection mechanism of FIG. 9.

FIG. 11 is a cross-sectional view taken along line XI-XI in FIG. 9.

FIG. 12 is a side elevational view of an inner tubular element of a telescoping ladder stability bar suitable for use in a portable tree stand constructed in accordance with principles of the present disclosure.

FIG. 13 is a fragmentary top plan view of the inner tubular element of FIG. 12.

FIG. 14 is a top plan view of an outer tubular element of a telescoping ladder stability bar for use with the inner tubular element of FIG. 12.

### DETAILED DESCRIPTION OF VARIOUS EMBODIMENTS

Embodiments of a tree stand and a system for hunting are disclosed herein. A portable tree stand can include a base and a ladder removably attached thereto. The base can include a platform and an attachment bracket mounted to the platform. The ladder can be movable over a range of travel between a collapsed position and an extended position. The ladder can include a set of rungs. The ladder can be removably attached to the attachment bracket of the base. A backpack assembly can be provided that is securable to the ladder to facilitate the transportation of the ladder by a user carrying the ladder as a backpack. The ladder can be converted into a ladder cart by attaching a wheel assembly with a fold-out game carrier attached to one end and a handlebar assembly attached to the other end of the ladder.

In some embodiments, a base of the portable tree stand can include a universal attachment bracket adapted to removably attach a telescoping ladder to the base. A plurality of similar bases can be provided and used with a single telescoping ladder. The bases can be respectively secured in an elevated position to a corresponding plurality of trees in a hunting area.

An outdoorsman can use the telescoping ladder with any one of the bases secured to the various trees to allow the user to climb the ladder up to the base secured in an elevated position to the tree and use the base for hunting/observation. The user can disconnect the ladder from the base, leaving the base in the elevated position on the tree, and transport the ladder to a second base secured to a second tree. The user can connect the ladder to the second base, climb the ladder to reach the second base, and use the second base in the elevated position on the second tree as another hunting/observation site.

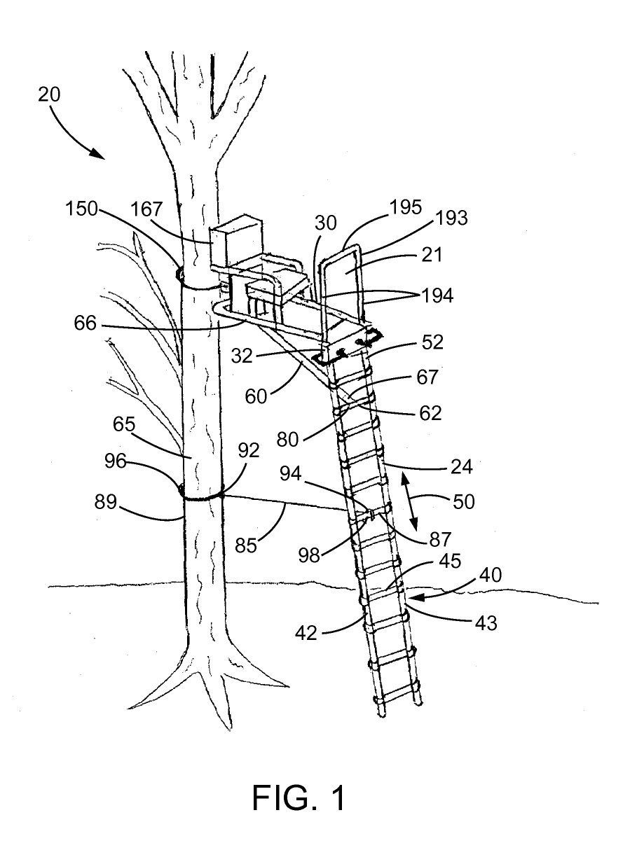

Turning now to the Figures, there is shown in FIG. 1 an embodiment of a tree stand 20 constructed in accordance with the present disclosure. The tree stand 20 can include a base 22 and a telescoping ladder 24.

The base 21 includes a platform 30 and a universal attachment bracket 32 mounted to the platform 30. The ladder 24 is removably connected to the base 21 via the universal attachment bracket 32.

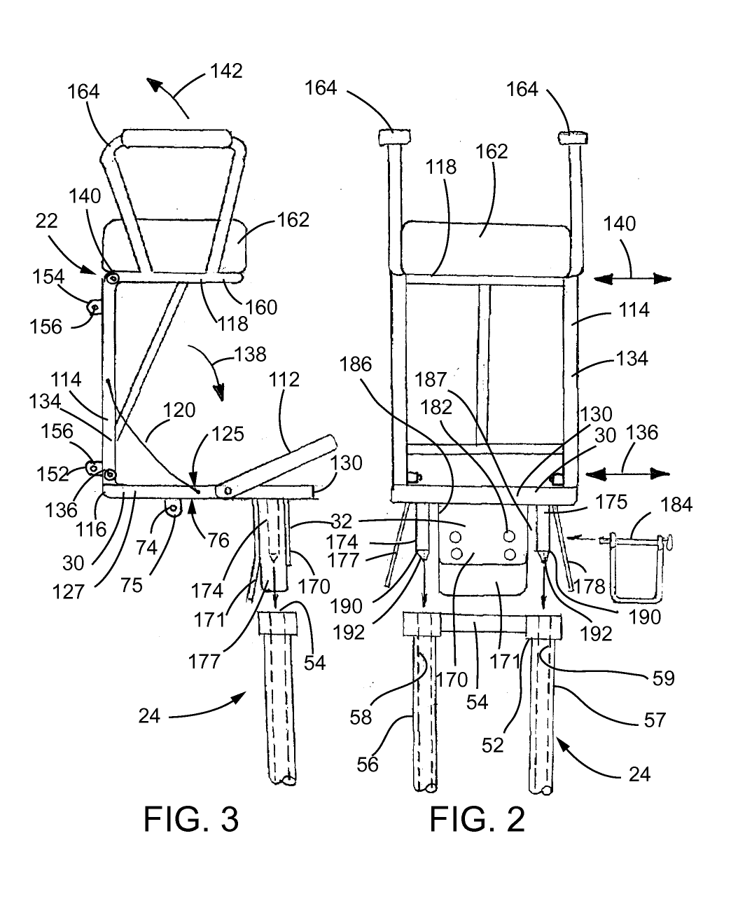

The ladder 24 is telescopically movable over a range over travel between a collapsed position and an extended position. The ladder 24 includes a plurality of rung segments 40 each having a pair of columns 42, 43 and a rung 45 extending between the columns 42, 43. The columns 42, 43 of one rung segment 40 are disposed in respective nesting relationship with the columns 42, 43 of each adjacent rung segment 40 to facilitate the telescopic movement of the ladder along a longitudinal axis 50 thereof The ladder 24 includes a top rung segment 52 having a top rung 54. The top rung 54 of the telescoping ladder 24 is removably connectable to the attachment bracket 32 of the base 21, 22 (see FIG. 2).

A base stability bar 60 can be removably connected to the base 21 and a predetermined intermediate rung 62 of the telescoping ladder 24 to provide additional stability to the base 21 when the base 21 is secured in an elevated position to a tree 65 and the ladder 24 is attached to the attachment bracket 32 of the base 21. The base stability bar 60 has a first end 66 removably connectable to the platform 30 of the base 21 and a second end 67 removably connectable to the intermediate rung 62 of the telescoping ladder 24.

The first end 66 includes a mounting hole through which a fastening element such as a bolt, locking pin, or other suitable fastening member can extend. The fastening element can be inserted through an eyelet 74 of an attachment member 75 disposed on an underside 76 of the platform 30 (see FIG. 2) and the mounting hole of the first end 66 of the base stability bar 60 to connect the base stability bar 60 to the platform 30. The second end 67 of the base stability bar 60 can include a jaw 80 having a substantially U-shaped cross section that is adapted to retentively engage one of the intermediate rungs 62 of the telescoping ladder. In the illustrative embodiment, the intermediate rung 62 used to support the base stability bar 60 is the third rung from the top of the ladder 24. A suitable fastener, such as a hook-and-loop fastener, for example, can be associated with the jaw 80 to securely retain the rung 62 within the jaw 80.

A telescoping ladder stability bar 85 can be provided that is engageable with one of a number of intermediate rungs 87 of the telescoping ladder 24 and a trunk 89 of the tree 65 to enhance the stability of the ladder 24 for a user when traversing the ladder rungs up to and down from the base 21 when the base 21 is in an elevated position and secured to the trunk 89 of the tree 65. The ladder stability bar 85 can have a first end 92 adapted to engage a tree and a second end 94 removably connectable to one of the intermediate rungs 87 of the telescoping ladder 24. The first end 92 can include a pair of eyelets 93 each adapted to receive a hook disposed at a respective end of a ratcheted tie-down strap 96 or other suitable fastening device (see FIG. 14).

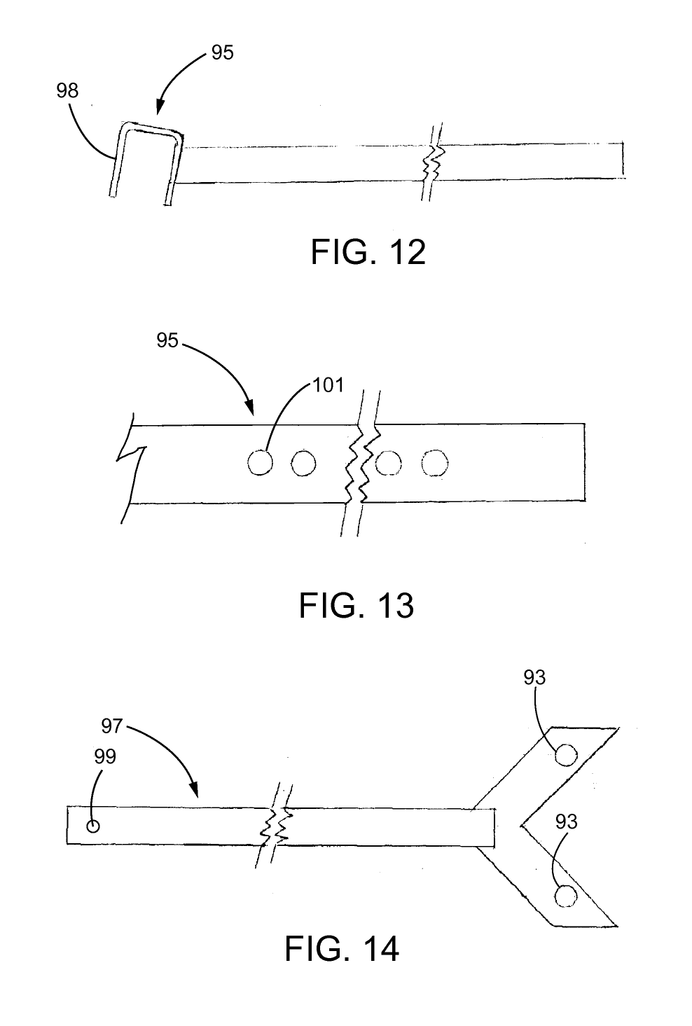

The telescoping ladder stability bar 85 can include an inner tubular element 95 and an outer tubular element 97 adapted to telescopically move relative to each other along a longitudinal axis of the ladder stability bar 85 (see FIGS. 12-14). A fastening element, such as a thumbscrew threadedly engaged in a tapped hole 99 in the outer tubular element 97, for example, can be used to secure the tubular elements 95, 97 in fixed relationship to each other. In other embodiments, the inner tubular element 95 can include a plurality of mounting holes 101 that can be incrementally aligned with the hole 99 of the outer tubular element 97 so that a lock pin can be inserted therethrough to retain the inner and outer tubular elements 95, 97 with respect to each other.

In use, the inner and outer tubular members 95, 97 can be moved relative to each other such that the ladder stability bar 85 substantially spans the horizontal distance between the intermediate rung 87 to which it is attached and the trunk 89 of the tree 65. The fastening element can be used to fix the inner and outer tubular members relative to each other, and the ladder stability bar 85 can be secured to the ladder 24 and the tree 65. In some embodiments, the base stability bar 60 can also include inner and outer tubular elements that are telescopically movable with respect to each other so that the length of the base stability bar 60 can be adjusted.

The ratcheted tie-down strap 96 can be wrapped around the trunk 89 of the tree 65 and interengaged with the eyelets 93 of the first end 92 of the ladder stability bar 85. The ratchet mechanism of the tie-down strap 96 can be operated to cinch the strap 96 tightly around the trunk 89 to secure the first end 92 of the ladder stability bar 85 to the trunk 89 of the tree 65.

The second end 94 of the ladder stability bar 85 can include a jaw 98 having a substantially U-shaped cross section that is adapted to retentively engage an intermediate rung 87 of the telescoping ladder 24. The jaw 98 of the second end 94 of the ladder stability bar 85 can receive a rung of the telescoping ladder such that a portion of the jaw 98 extends beyond the rung 87. The extending portion of the jaw 98 can include a pair of mounting holes adapted to receive a fastening element, such as a locking pin, for example, therethrough to securely hold the rung 87 in the jaw 98 of the ladder stability bar 85.

Referring to FIGS. 2-4, an illustrative base 22 includes the platform 30, a footrest bar 112 pivotally mounted to the platform 30 (omitted from FIG. 2 for illustrative purposes), a tree-engaging support assembly 114 pivotally mounted to a rear end 116 of the platform 30, a seat assembly 118 pivotally mounted to the support assembly 114, and the universal bracket attachment 32 projecting from the platform 30. The base 22 shown in FIGS. 2-4 is similar to the base 21 shown in FIG. 1. It should be understood that the description of one base is applicable to the other base, as well. Accordingly, similar reference numbers will be used for both bases 21, 22.

The base 22 is movable between an operative and a folded position. A pair of cables 120 can interconnect the platform 30 and the sides of the support assembly 114 to allow for the movement of the base 22 between a folded, stored position and an operational position where the cables can help to tensionally hold the platform 30.

The platform 30 is substantially planar. The platform 30 can include an upper support surface 125, made of wire mesh, for example, disposed over a rigid support structure 127. The platform 30 can have various sizes in different embodiments.

The footrest bar 112 is connected to the platform 30. The footrest bar 112 is disposed adjacent a front end 130 of the platform 30. The footrest bar 112 is adjustable such that the elevation of the bar 112 relative to the upper support surface 125 of the platform 30 can be varied.

The support assembly 114 can include a rigid frame 134. The support assembly 114 is shown in an operational position in FIG. 3. The support assembly 114 can pivot about a lower axis 136 in a folding direction 138 from the operational position shown to the stored position in which the support assembly 114 is adjacent the platform 30. When the support assembly 114 moves in the folding direction 138, the seat assembly 118 can pivot about an upper axis 140 of the support assembly 114 in a retracting direction 142 to facilitate the movement of the base 22 to the folded position.

The base 22 can include a fastening element 150 (see FIG. 1) adapted to secure the base 22 in an elevated position to a range of trees having different trunk sizes. In some embodiments, the fastening element 150 can comprise a tie-down strap having a ratchet mechanism to facilitate the secure connection between the base and the trunk of the tree. In some embodiments, the fastening element 150 can be adapted to allow the base to be secured to a tree having a trunk of at least eight inches, for example.

Referring to FIG. 3, a ratcheted tie down strap or other suitable fastening element can be connected to the support assembly 114 using either a pair of lower attachment members 152 or a pair of upper members 154. A respective end of the fastening element 150 can be secured to the desired attachment members using eyelets 156 defined therein. The fastening element 150 can be wrapped around the tree trunk and cinched tightly thereto, to thereby mount the base 22 to the tree in an elevated position.

The seat assembly 114 can include a rigid support frame 160 supporting a cushioned seat 162 and a pair of arm rests 164 extending from the sides of the seat 162. The seat 162 is disposable in spaced relationship to the platform 30. The seat 162 can be disposed a predetermined height above the platform 30 when the seat assembly 114 is in the upright position. In some embodiments, the seat 162 can be disposed about twenty inches above the platform 30 when the seat assembly 114 is in the upright position. The seat assembly 114 can include a three-way adjustable seat 162. The cushion seat 162 can be covered in a suitable material, such as vinyl, for example. The aim rests 164 respectively extend from the sides of the seat 162. In other embodiments, the seat assembly can include a backrest support assembly 167 (see FIG. 1)

Referring to FIGS. 2 and 3, the attachment bracket 32 system allows the hunter to readily connect the ladder 24 to the base 22 of the tree stand. The universal attachment bracket 32 can be mounted to the platform 30 of the base 22. The attachment bracket 32 can include a pair of spaced apart retaining walls 170, 171, a pair of pins 174, 175 disposed in lateral outward relationship to the retaining walls 170, 171, and a pair of guide flanges 177, 178 respectively disposed in lateral outward relationship to the pins 174, 175.

The retaining walls 170, 171 of the attachment bracket 32 extend from the underside surface 76 of the platform 30. The retaining walls 170, 171 are in spaced relationship to each other such that the top rung 54 is disposable between the retaining walls 170, 171. Each retaining wall 170, 171 includes a plurality of mounting holes 182. The mounting holes 182 of the retaining walls 170, 171 are respectively aligned with each other and adapted to receive a locking pin 184 therethrough.

The illustrative retaining walls 170, 171 can include two pairs of mounting holes 182 with a pair of mounting holes disposed adjacent each lateral end 186, 187 thereof such that a pair of mounting holes 182 of one retaining wall 170 substantially aligns with a pair of mounting holes 182 of the other retaining wall 171. The retaining walls 170, 171 can be adapted to accommodate the top rung 54 of the telescoping ladder 24 therebetween such that at least one pair of mounting holes 182 can be in offset lower relationship to the top rung 54 of the ladder 24 so that a locking pin 184 inserted through the lower mounting holes 182 can prevent the top rung 54 from being removed from between the retaining walls 170, 171 and effectively interlocking the ladder 24 to the base 22 through the attachment bracket 32.

The pins 174, 175 of the attachment bracket 32 project from the underside surface 76 of the platform 30. The pins 174, 175 are in spaced relationship to each other. The pins 174, 175 are disposed in lateral outward relationship to the retaining walls 170, 171.

The top rung segment 52 of the telescoping ladder 24 includes a pair of columns 56, 57 each defining a socket 58, 59. The sockets 58, 59 are adapted to respectively receive therein the pins 174, 175 of the attachment bracket 32.

The pins 174, 175 can be disposed with respect to each other to be able to both be inserted into a respective socket 58, 59 at a top end of each telescoping ladder column 56, 57 of the telescoping ladder 24. Each pin 174, 175 can include a distal, projecting end 190 that has a generally frustoconical pilot portion 192 to facilitate the insertion of the pin 174, 175 into a mating socket 58, 59 of the telescoping ladder 24.

The guide flanges 177, 178 of the attachment bracket 32 extend from the underside surface 76 of the platform 30. The guide flanges 177, 178 can be positioned with respect to each other to allow the telescoping ladder 24 to fit laterally therebetween. The guide flanges 177, 178 are disposed in lateral outward relationship to the retaining walls 170, 171 and in spaced relationship to each other such that the columns 58, 59 of the top rung segment 52 are disposed between the guide flanges 177, 178 when the top rung 54 is connected to the attachment bracket 32 of the base 22. The guide flanges 177, 178 are disposed in lateral outward relationship to the pins 174, 175.

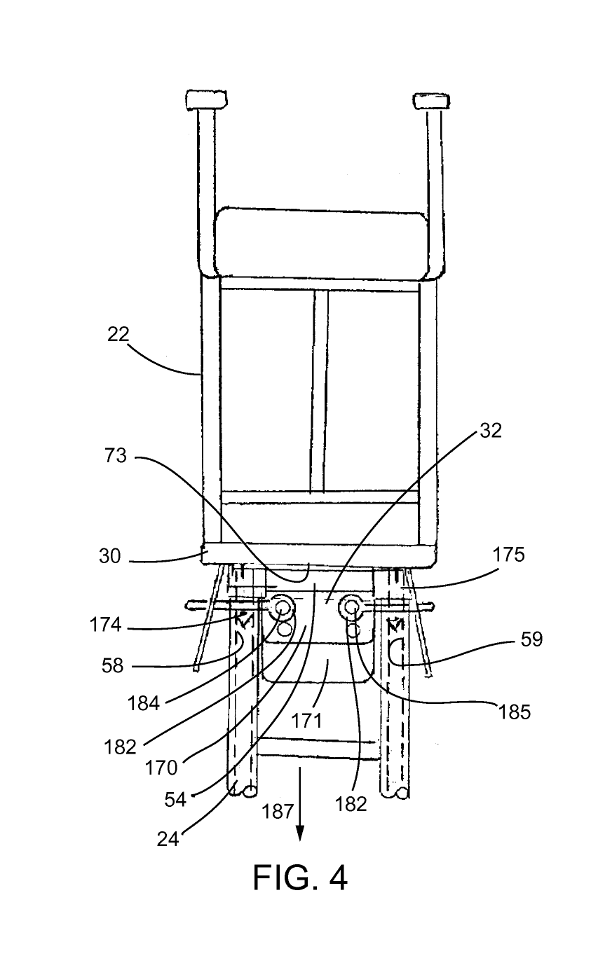

Referring to FIG. 4, with the top rung 54 disposed between the underside surface 76 of the platform 30 and the mounting holes 182 of the retaining walls 170, 171, a pair of fastening elements, such as, locking pins 184, 185, for example, can be inserted through the mounting holes 182 to securely retain the top rung 54 of the telescoping ladder 24 between the retaining walls 170, 171 and the locking pins 184 can be provided that extend through the mating pairs of mounting holes 182 to retain the top rung 54 of the telescoping ladder 24 in place such that the top rung 54 is constrained from moving in a retracting direction 187 relative to the attachment bracket 32 away from the platform 30 of the base 22.

The pins 174, 175 are respectively matingly received within the sockets 58, 59 of the ladder 24 to further interlock the telescoping ladder 24 with the base 22. The attachment pins 174, 175 enhance the stability of the ladder 24 when a user is ascending and descending. The positive mechanical engagement between the attachment pins 174, 175 and the sockets 58, 59, respectively, of the telescoping ladder 24 help removably attach the ladder 24 to the base 22.

The structural components of the base 22 can be made from any suitable material, such as steel, for example. The base 22 can be constructed such that it can support a predetermined weight. In some embodiments, the base can have a three hundred pound weight rating.

In some embodiments, the base 22 can be equipped with a pair of serrated jaws which are disposed on a tree-engaging side thereof. The jaws define a V-shaped notch in which the trunk of the tree can be located. The serrated jaws help the base retentively engage the trunk in an elevated position. The tree grippers can be made from any suitable material, such as ten-gauge steel, for example.

In some embodiments, the base 22 can include an adjustable shooting rail assembly 193 (see FIG. 1) that includes a pair of uprights 194 with a shooting rail 195 extending between the uprights 194. Each upright 194 can include a pair of segments that are telescopically movable with respect to each other to allow the height of the shooting rail 195 relative to the platform to be adjustable. A pair of tightening screws can be used to secure the segments of each upright 194 in fixed relationship to each other to hold the shooting rail 195 in position once it is adjusted to a user's preference.

The tie down straps of the portable tree stand can be any suitable type of strap that can secure the component is question to the item to which it is being mounted. Suitable straps can include straps, webbing, rope, cord, braided wire, chain, and other items as will be appreciated by those skilled in the art. In other embodiments, other fastening elements can be used in lieu of, or in addition to, the illustrative tie down straps.

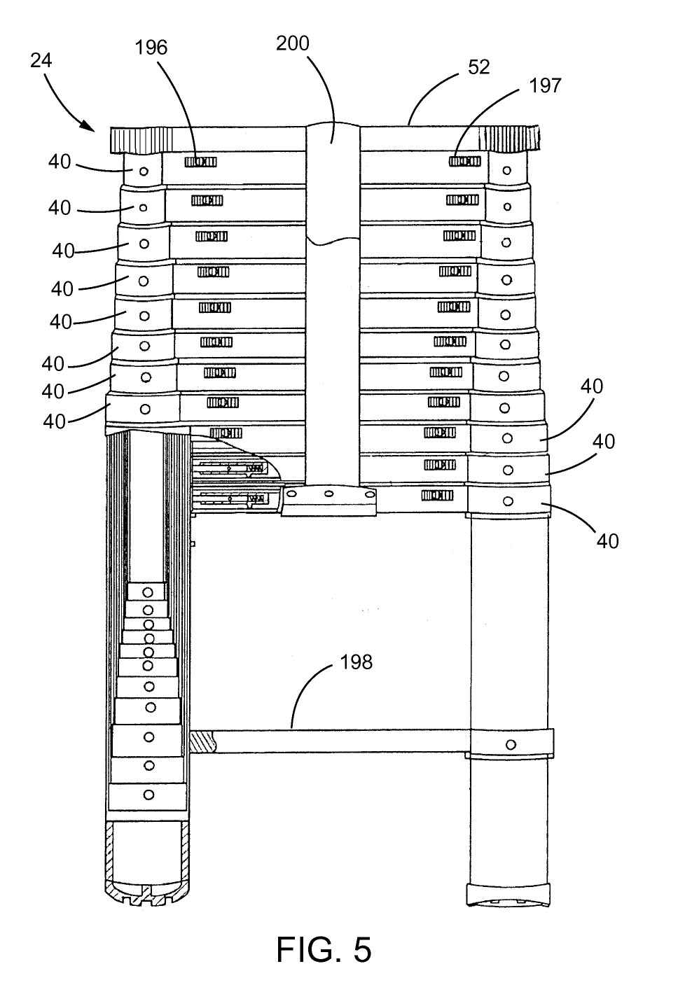

Referring to FIG. 5, the telescoping ladder 24 is shown in a collapsed position. Each rung segment 40, 52 can be adapted to interlock with an adjacent rung segment 40 to lock the rung segments 40 together. Each rung segment 40, 52 is adapted to be selectively position in either an extended state or a collapsed state relative to a lower adjacent rung segment 40. Each rung segment 40, 52 includes a suitable mechanism to retain the rung segment in the selected state until a user desires to change the state of the rung segment. For example, each rung segment 40 can include a pair of thumb release mechanisms 196, 197 to selectively release the rung segment 40 to allow the ladder to be incrementally extended or collapsed a rung segment 40 at a time. A fixed lower rung 198 can be provided to help provide stability to the ladder 24. The illustrative ladder 24 has twelve rungs. The ladder 24 can include a closure strap 200 to further secure the ladder 24 in the collapsed position.

The telescoping ladder 24 can be constructed from any suitable material, such as, lightweight aircraft grade aluminum (e.g., 6061 Alloy), for example. An illustrative ladder 26 can weigh about 26 pounds and have a closed height of about 3.5 feet in the collapsed position, a maximum open height of about 12.5 feet in the fully extended position, and a width of about 19 inches. Embodiments of the telescoping ladder 24 can be similar in construction and function to those shown and described in U.S. Pat. Nos. 6,708,800; 6,883,645; and 7,048,094, which are incorporated herein by reference.

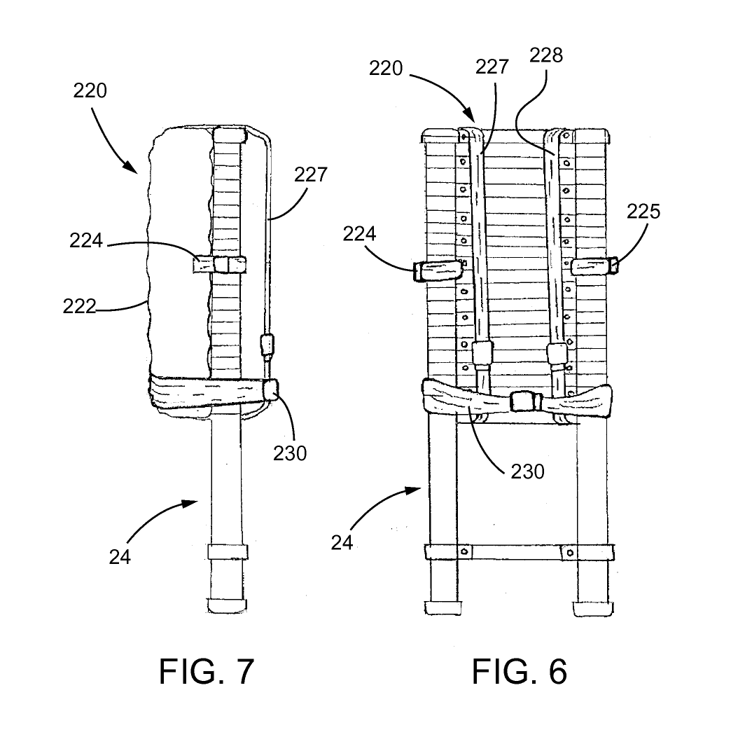

Referring to FIGS. 6 and 7, a backpack assembly 220 adapted to be removably connected to the telescoping ladder 24 is shown. The backpack assembly 220 includes a compartment 222, a pair of ladder fastening straps 224, 225 adapted to secure the compartment 222 to the ladder 24, a pair of adjustable shoulder straps 227, 228 adapted to be worn over the shoulders of a user to allow the user to transport the telescoping ladder 24 and the backpack assembly 220, and an adjustable waist strap 230 to be worn around the transporting user's waist to facilitate the transportation of the ladder 24. The backpack compartment 222 can be constructed from light weight/heavy duty canvas. In other embodiments, the backpack assembly 220 can include ladder fastening straps, adjustable shoulder straps and a waist strap extending from a back cushion provided to improve the comfort of wearing the backpack.

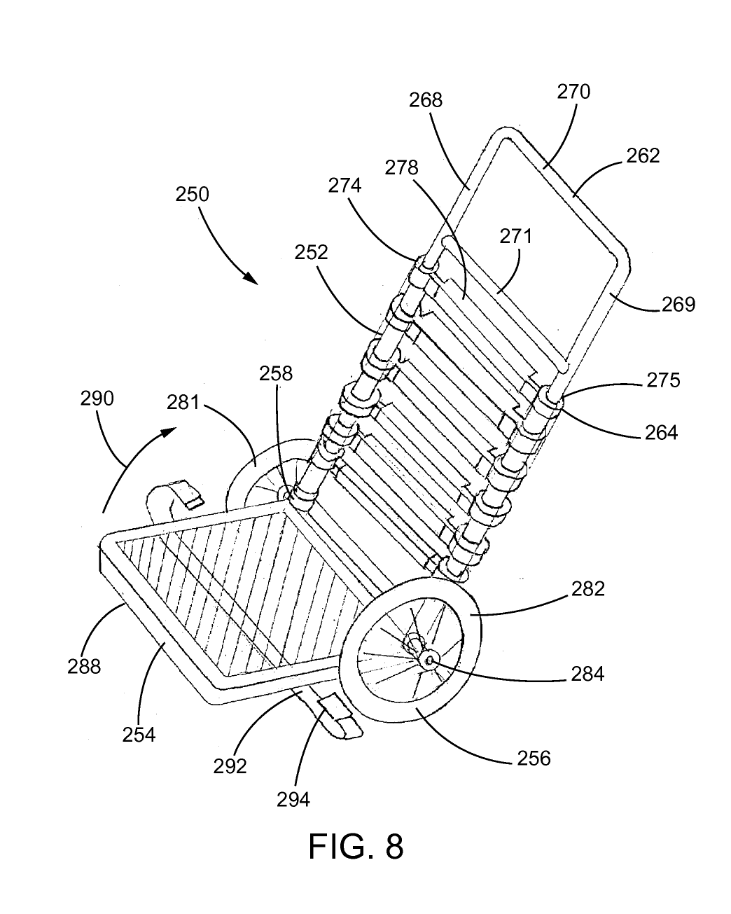

Referring to FIG. 8, an embodiment of a ladder cart 250 is shown. The ladder cart 250 can be constructed from a telescoping ladder 252 suitable for use with a tree stand constructed in accordance with principles of the present disclosure. The ladder cart 250 includes the telescoping ladder 252, a fold-out game carrier 254 and a wheel assembly 256 removably mounted to one end 258 of the ladder 252, and a handle bar 262 removably mounted to the other end 264 of the ladder 252.

The handle bar 262 includes a pair of support members 268, 269 and a pair of cross bars 270, 271 extending between the support members 268, 269. The support members 268, 269 are adapted to matingly fit in sockets 274, 275 of a top rung segment 278 of the telescoping ladder 252 to removably engage the handlebar 262 with the telescoping ladder 252.

The wheel assembly 256 is adapted to be removably connected to the bottom end 258 of the ladder 252. The illustrative wheel assembly 256 includes a pair of twenty inch no-flat wheels 281, 282 rotatably mounted to an axle 284.

The fold-out carrier platform 254 is pivotally mounted to the wheel assembly 256. The carrier platform 254 is pivotally movable with respect to the wheel assembly 256 over a range of travel between an extended position (shown in FIG. 8) and a stowed position. A distal end 288 of the game carrier platform 254 can be rotated in a folding direction 290 from the extend position toward the telescoping ladder 252 to move the game carrier platform 254 to the stowed position. The fold-out game carrier platform 254 can have a strap 292 having a fastening buckle 294 for use to help secure an item being transported on the carrier platform 254 to it.

The fold-out game carrier 254 can be made from any suitable materials, such as steel, for example. In other embodiments, the fold-out game carrier 254 can be made from utility grade heavy duty canvas.

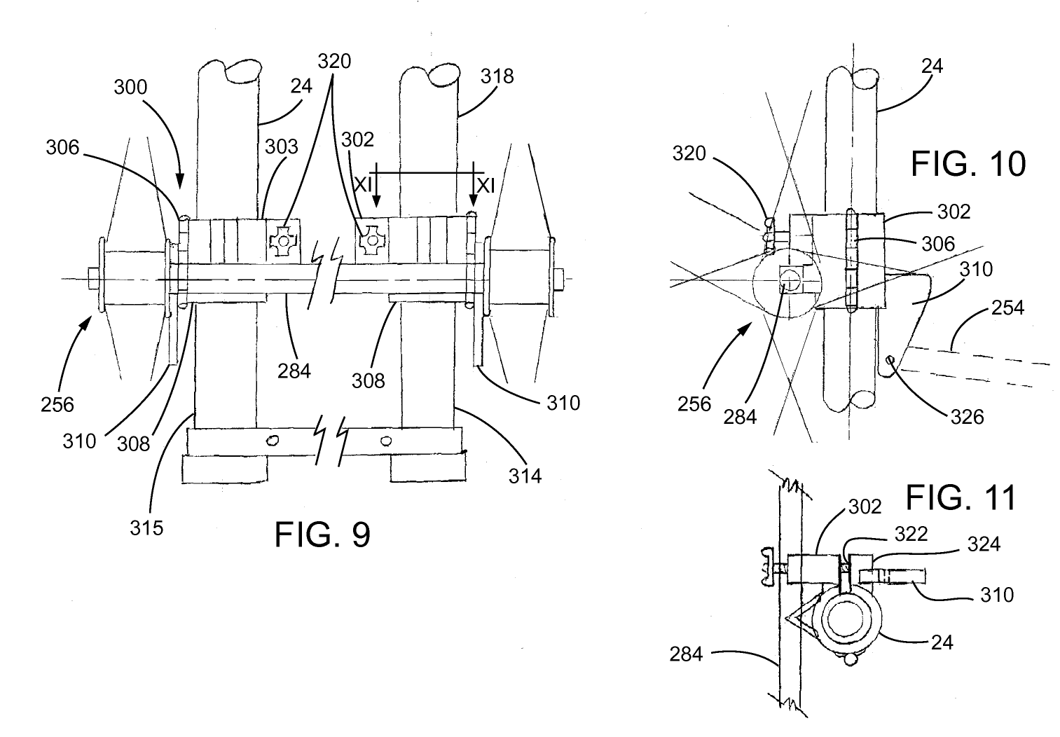

Referring to FIGS. 9-11, an illustrated embodiment of a connecting mechanism 300 adapted to removably attach the wheel assembly 256 and the fold-out carrier platform 254 to the ladder 24 is shown. The connecting mechanism 300 includes a pair of connector assemblies 302, 303 mounted adjacent a respective wheel 281, 282 of the wheel assembly 256. Each connector assembly 302, 303 includes a hinged clamp 306, a bearing 308 for rotatably supporting the axle 284 of the wheel assembly 256, and a game carrier bracket 310 adapted to pivotally support the fold-out the game carrier platform 254. The hinged clamp 306 can be removably attached to a respective column 314, 315 of a lower rung segment 318 of the ladder 24. Each hinged clamp 306 can include a threaded clamp adjustment knob 320 adapted to retentively secure the hinged clamp 306 to the respective column 314, 315. The clamp adjustment knob 320 can be tightened to securely connect each hinged clamp 306 to the respective column 314, 315. The threaded knob 320 can engage a threaded hole 322 in a bracket 324 of the hinged clamp 306 to produce a secure mechanical fit therebetween. The fold-out game carrier platform 256 can pivot about the game carrier brackets 310 via a suitable pivot axis, such as a pin 326, for example.

In use, a user can transport the portable tree stand 20 to a desired site. The base 22 can be transported in a folded position. The support assembly 114 can be pivoted about the lower axis 136 from a stored position to an operational position in which the support assembly 114 projects upwardly from the platform 30. The support assembly 114 can be locked in place in the operational position by a locking pin or other suitable locking element. The seat assembly 118 can be placed in a seating position so that the seat 162 is in spaced relationship to the platform 30.

The ladder 24 can be removably attached to the base 22. In one arrangement, the top rung 54 of a telescoping ladder 24 can be attached to a universal attachment bracket 32 extending from the platform 30 of the base 22. The top rung 54 of the telescoping ladder 24 can fit within a pair of retaining walls 170, 171 of the attachment bracket 32 so that at least one locking pin can be inserted through a pair of mating mounting holes 182 in the retaining walls 170, 171 such that the locking pin prevents the removal of the top rung 54 from the attachment bracket 32.

The telescoping ladder 24 and the attached base 22 can be placed in an upright position. The telescoping ladder 24 can be movable over a range of travel between a collapsed position and an extended position. The ladder 24 can be placed in the collapsed position to facilitate the movement of the assembly into an upright position. The ladder 24 can support the base 22 as the ladder 24 is raised from the collapsed position to the extended position, or lowered from an extended position toward the collapsed position. With the base and ladder assembly in the upright position, an upper portion of the telescoping ladder 24 can be extended to accommodate a base stability bar 60. The base stability bar 60 can be removably attached to the base 22 and a selected, extended rung 62 of the upper portion of the ladder 24. In some embodiments, the third rung 62 from the top of the ladder 24 can be used to secure the base stability bar 60 to the ladder 24.

One or more of the remaining rungs 45 of the telescoping ladder 24 can be extended to place the base 22 in a desired elevated position relative to the surface supporting the bottom of the ladder 24. The base 22 can be supported against an object to which it will be attached, such as a tree 65, for example.

A ladder stability bar 85 can be secured to an intermediate ladder rung 87 and the object 65 to which the base is to be secured (e.g., a tree). The ladder stability bar 85 can be secured to the object 65 using a fastening element 96 such as a tie-down strap, for example. The other end of the ladder stability bar can have a U-shaped clamping jaw 98 and a locking pin adapted to secure the ladder stability bar 85 to an intermediate rung 87 of the ladder 24.

A suitable fastening element 150, such as, a tie-down strap, for example, can be used to secure the base 22 to the trunk 89 of the tree 65 in an elevated position (as shown in FIG. 1, for example). The ladder 24 can provide a safe and convenient means for climbing up to the base 22 in an elevated position on a tree 65. The user can use the base 22 in the elevated position as a hunting/observation site.

The user can keep the base 22 secured to the tree 65 in an elevated position and use the ladder 24 for other purposes. For example, at the end of a given day, the user can disconnect the ladder 24 from the base 22, use the ladder 24 to climb down from the base 22 in the elevated position, and remove the ladder 24 from the attachment bracket 32 of the base 22, thereby leaving the base 22 in an elevated position upon the tree 65. The removal of the ladder 24 allows the base 22 to remain secured up in an elevated position on the tree 65 for use at a later time for hunting/observation, while helping prevent the theft or unauthorized use of the base 22 when the ladder 24 is removed.

The user can transport the telescoping ladder 24 from the site, using a backpack assembly 220, for example. The user can convert the ladder 24 into a ladder cart 250 by attaching a wheel assembly 256 and a game carrier platform 254 to one end of the ladder 24 and a handlebar 262 to the other end of the ladder 24 to facilitate use of the ladder 24 as a ladder cart.

The ladder 24 can be used as a conventional ladder independent of its arrangement with the base 22. For example, the telescoping ladder 24 can be used for performing common household activities, such as accessing roof gutters of a residence, e.g.

To remove the ladder 24 from a base 22 secured to a tree in an elevated position, the use can stand upon a selected rung of the ladder. Lock pins can be removed from the mounting holes 182 of the retaining walls 170, 171 of the attachment bracket 32. The user can fully descend from the ladder 24, standing upon the ground. The user can detach the ladder stability bar 85 from the ladder 24, e.g., by removing a lock pin from the clamping jaw of the ladder stability bar 85. The base stability bar 60 can also be disengaged from the ladder 24. With the stability bars 60, 85 disengaged from the ladder 24, the ladder 24 can be detached from the attachment bracket 32 by moving the top rung 54 from out between the retaining walls 170, 171 of the attachment bracket 32. The ladder 24 can be moved into the collapsed position to facilitate the transportation of the ladder 24. The base 22 can be left secured to the tree in an elevated position.

The user can return to the site of the first base 22 mounted in an elevated position to a tree or to any one of a number of similar bases also secured in elevated positions to respective trees or other objects. To use a telescoping ladder 24 with a base 22 mounted to a tree in an elevated position, the user can removably attach the ladder 24 to the universal attachment bracket 32 of a base mounted to a tree in an elevated position. One end of a ladder stability bar 85 can be attached to an intermediate rung 87 of the ladder 24 and the other end to the trunk of the tree. One end of the base stability bar 60 can be connected to the base 22 and the other end to a predetermined rung 62 of the ladder 24. Locking pins can be inserted through mounting holes 182 in the retaining walls 170, 171 of the universal attachment bracket 32 to prevent the top rung 54 of the ladder 24 from disengaging from the attachment bracket 32.

When a user desires to remove a base 22 secured in an elevated position to a tree, the user can remove the fastening element 150 securing the base 22 to the tree such that the base 22 is disengaged from the tree. The user can climb down the ladder 24. The user can disengage the ladder stability bar 85 from the tree and from the ladder 24. The user can collapse a lower portion of the telescoping ladder 24, with the ladder 24 supporting the base 22, so that the rung 62 supporting the base stability bar 60 is within easy reach of the user when the user is standing on the ground with the assembly in an upright position. The assembly can be lowered to the ground. The base stability bar 60 can be removed from the rung 62 of the ladder 24 to which it is attached and from the platform 30 of the base 22. The ladder 24 can be removed from the attachment bracket 32 by withdrawing the locking pins 184 and moving the top rung 54 of the ladder 24 out from between the retaining walls 170, 171, thereby respectively withdrawing the pins 174, 175 from the sockets 58, 59 of the ladder 24. The telescoping ladder 24 can be moved into the fully collapsed position. The base 22 can be moved into the folded position to further facilitate the transportation of the components of the portable tree stand 20.

The hunting system can include a four-point safety harness for a hunter to wear while traversing the ladder 24 and while using a base 22 attached in an elevated position to a trunk of a tree. One ladder 24 can be used with a plurality of bases each having a universal attachment bracket 32 mounted thereto to allow the hunter to readily access to multiple tree stand locations. Easy attachments and light-weight components allow the hunter to raise the tree stand straight up in the tree to any desired height up to about 18.5 feet in some embodiments.

A hunter can use the ladder 24 to climb a tree to determine whether or not the tree is a desired spot from which to hunt prior to hanging the base 22 in the tree. The ladder 24 can be used as a climbing tool to allow the hunter to cut shooting lanes at a desired location for hanging the base. The ladder 24 can be used as a game locator after the shot. The ladder cart 250 can be used to haul out game from a hunting site.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A portable tree stand comprising:
a base, the base including a platform and an attachment bracket mounted to the platform; and
a ladder, the ladder being movable over a range over travel between a collapsed position and an extended position, the ladder including a set of rungs;
wherein the ladder is removably attached to the attachment bracket of the base.

2. The portable tree stand of claim 1, wherein the base includes a seat disposable in spaced relationship to the platform.

3. The portable tree stand of claim 1, wherein the base includes a support assembly pivotally mounted to the platform and a seat assembly pivotally mounted to the support assembly.

4. The portable tree stand of claim 3, wherein the base includes a footrest bar connected to the platform.

5. The portable tree stand of claim 3, wherein the base includes a fastening element adapted to secure the base in an elevated position to a range of trees having different trunk sizes.

6. The portable tree stand of claim 1, wherein the base includes a fastening element adapted to secure the base in an elevated position to a range of trees having different trunk sizes.

7. The portable tree stand of claim 1, wherein the attachment bracket includes a pair of retaining walls extending from the platform, the retaining walls in spaced relationship to each other such that one of the rungs of the ladder is disposable between the retaining walls.

8. The portable tree stand of claim 7, wherein each retaining wall includes a mounting hole, the mounting holes of the retaining walls being aligned with each other and adapted to receive a locking pin therethrough.

9. The portable tree stand of claim 1, wherein the attachment bracket includes a pair of pins projecting from the platform, the pins in spaced relationship to each other, and the ladder includes a top rung segment having a pair of columns, each column defining a socket, the sockets adapted to respectively receive therein the pins of the attachment bracket.

10. The portable tree stand of claim 7, wherein the attachment bracket includes a pair of pins projecting from the platform, the pins in spaced relationship to each other, and wherein the ladder includes a top rung segment having a pair of columns, each column defining a socket, the sockets adapted to respectively receive therein the pins of the attachment bracket.

11. The portable tree stand of claim 10, wherein the pins are disposed in lateral outward relationship to the retaining walls.

12. The portable tree stand of claim 1, wherein the ladder includes a top rung segment having a top rung and a pair of columns, and wherein the attachment bracket includes a pair of guide flanges extending from the platform, the guide flanges disposed in spaced relationship to each other such that the columns of the top rung segment are disposed between the guide flanges when the top rung is connected to the attachment bracket of the base.

13. The portable tree stand of claim 7, wherein the ladder includes a top rung segment having a top rung and a pair of columns, and wherein the attachment bracket includes a pair of guide flanges extending from the platform, the guide flanges disposed in lateral outward relationship to the retaining walls and in spaced relationship to each other such that the columns of the top rung segment are disposed between the guide flanges when the top rung is connected to the attachment bracket of the base.

14. The portable tree stand of claim 10, wherein the ladder includes a top rung segment having a top rung and a pair of columns, and wherein the attachment bracket includes a pair of guide flanges extending from the platform, the guide flanges disposed in lateral outward relationship to the retaining walls and to the pins and in spaced relationship to each other such that the columns of the top rung segment are disposed between the guide flanges when the top rung is connected to the attachment bracket of the base.

15. The portable tree stand of claim 14, wherein the pins are disposed in lateral outward relationship to the retaining walls.

16. The portable tree stand of claim 1, wherein the ladder is removably connectable to the attachment bracket of the base such that the ladder supports the base to allow the base to move to an elevated position by moving the telescoping ladder from the collapsed position toward the extended position.

17. The portable tree stand of claim 1, wherein the ladder includes a plurality of telescoping rung segments, each rung segment having a pair of columns and a rung extending between the columns, the columns of one rung segment being disposed in respective nesting relationship with the columns of each adjacent rung segment, the ladder including a top rung segment having a top rung, wherein the top rung of the telescoping ladder is removably connectable to the attachment bracket of the base.

18. The portable tree stand of claim 1, further comprising:
a base stability bar having a first end removably connectable to the platform of the base and a second end removably connectable to a rung of the ladder.

19. The portable tree stand of claim 1, further comprising:
a ladder stability bar having a first end adapted to engage a tree and a second end removably connectable to a rung of the ladder.

20. The portable tree stand of claim 1, further comprising:
a backpack assembly adapted to be removably connected to the ladder, the backpack assembly including a pair of shoulder straps adapted to allow a user to transport the ladder and the backpack assembly.

21. The portable tree stand of claim 1, wherein the ladder includes a bottom end, and the top rung segment of the ladder includes a pair of columns each defining a socket, the tree stand further comprising:
a handle bar having a pair of support members and a cross bar extending between the support members, the support members adapted to matingly fit in the sockets to removably engage the handlebar with the telescoping ladder;
a wheel assembly adapted to be removable connected to the bottom end of the ladder;
a carrier platform mounted to the wheel assembly.

22. The portable tree stand of claim 21, wherein the carrier platform is pivotally movable with respect to the wheel assembly over a range of travel between a stowed position and an extended position.

23. A method of using a portable tree stand comprising:
attaching a ladder to a base, the base including a platform;
moving the ladder from a collapsed position to an extended position, the ladder supporting the base;
securing the base in an elevated position to an object;
disconnecting the ladder from the base, thereby leaving the base secured to the object in the elevated position.

24. The method of using a portable tree stand according to claim 23, wherein the base includes an attachment bracket mounted to the platform, and the ladder is attached to the base by removably attaching the ladder to the attachment bracket of the base.

25. The method of using a portable tree stand according to claim 23, wherein the ladder includes a plurality of telescoping rung segments, each rung segment having a pair of columns and a rung extending between the columns, the columns of one rung segment being disposed in respective nesting relationship with the columns of each adjacent rung segment, the ladder being telescopically movable over a range of travel between the collapsed position and a fully-extended position.

26. The method of using a portable tree stand according to claim 23, further comprising:
attaching a base stability bar to the base and the ladder.

27. The method of using a portable tree stand according to claim 23, further comprising:
attaching a ladder stability bar to the ladder and the object.

28. The method of using a portable tree stand according to claim 23, further comprising:
moving the ladder from the object to a second object, the second object having a second based secured thereto in an elevated position;
attaching the ladder to the second base.

29. The method of using a portable tree stand according to claim 28, further comprising:
attaching a backpack assembly to the ladder.

30. The method of using a portable tree stand according to claim 23, further comprising:
converting the ladder into a ladder cart by attaching a wheel assembly to the ladder.
